(19) United States
(12) Patent Application Publication
(10) Pub. No.: US 2018/0288328 A1
(43) Pub. Date: Oct. 4, 2018

(54) IMAGE PROCESSING APPARATUS, IMAGE PROCESSING METHOD, AND STORAGE MEDIUM

(71) Applicant: CASIO COMPUTER CO., LTD., Tokyo (JP)

(72) Inventor: Hiroshi SHIMIZU, Tokyo (JP)

(73) Assignee: CASIO COMPUTER CO., LTD., Tokyo (JP)

(21) Appl. No.: 15/915,018

(22) Filed: Mar. 7, 2018

(30) Foreign Application Priority Data
Mar. 28, 2017 (JP) 2017-063843

(51) Int. Cl. H04N 5/232; G06T 7/246; H04N 5/14; H04N 1/60

(52) U.S. Cl. CPC H04N 5/23254; H04N 1/6052; H04N 5/144; G06T 7/248

(57) ABSTRACT

An image processing apparatus includes a memory and a processor. The processor executes a program stored in a memory to perform operations including acquiring a moving image, calculating a similarity between the moving image and a candidate image which is to be synthesized temporally or spatially before or after the moving image, specifying a representative image from the moving image based on the calculation result, and generating a single image by combining the specified representative image and an image which includes the candidate image and which is different from the moving image.

This application is based on and claims the benefit of priority from Japanese Patent Application No. 2017-063843, filed on Mar. 28, 2017, the content of which is incorporated herein by reference.

### BACKGROUND OF THE INVENTION

### Field of the Invention

The present invention relates to an image processing apparatus, an image processing method, and a storage medium.

### Related Art

As disclosed in Japanese Unexamined Patent Application Publication No. 2016-066343, there is known a technique of generating an image by combining a predetermined number of images from a plurality of images.

### SUMMARY OF THE INVENTION

An image processing apparatus according to an embodiment of the present invention includes a memory and a processor. The processor executes a program stored in a memory to perform operations including acquiring a moving image, calculating a similarity between the moving image and a candidate image which is to be synthesized temporally or spatially before or after the moving image, specifying a representative image from the moving image based on the calculation result, and generating a single image by combining the specified representative image and an image which includes the candidate image and which is different from the moving image.

An image processing apparatus according to an embodiment of the present invention includes a memory and a processor. The processor executes a program stored in a memory to perform operations including acquiring a plurality of moving images, calculating a similarity between the moving image and a candidate image which is to be synthesized temporally or spatially before or after the moving image, specifying a representative image from the moving image based on the calculation result, and generating one representative image by combining the specified representative image and an image which includes the candidate image and which is different from the moving image.

An image processing method executed by an image processing apparatus according to an embodiment of the present invention includes a processor. The image processing method causes the processor to execute a program stored in a memory to perform operations including acquiring a moving image, calculating a similarity between the moving image a candidate image synthesized temporally or spatially before or after the moving image, specifying a representative image from the moving image based on a result of the calculation process, and generating a single image by combining the representative image specified by the specifying process and an image different from the moving image.

A non-transitory computer-readable storage medium according to an embodiment of the present invention stores a program that is executable by a computer that comprises a processor. The program is executable to cause the computer to perform operations including acquiring a moving image, calculating a similarity between a candidate image synthesized temporally or spatially before or after the moving image and the moving image, specifying a representative image from the moving image based on a calculation result of the calculation function, and generating a single image by combining the specified representative image and an image which includes the candidate image and which is different from the moving image.

### BRIEF DESCRIPTION OF THE DRAWINGS

More detailed understanding of the present application can be obtained by considering the following detailed description together with the following drawings:

FIG. 1 is a block diagram illustrating a hardware configuration of an image capture apparatus according to an embodiment of the present invention;

FIG. 2 is a schematic diagram illustrating an aggregate image generated in a first embodiment of the present invention;

FIG. 3 is a functional block diagram illustrating a functional configuration for executing a representative image extraction process in the first embodiment among functional configurations of the image capture apparatus in FIG. 1;

FIG. 4 is a flowchart illustrating an example of a flow of the representative image extraction process executed by an image capture apparatus as the first embodiment of the present invention having the functional configuration of FIG. 3;

FIG. 5 is a schematic diagram illustrating an aggregate image generated in a second embodiment;

FIG. 6 is a functional block diagram illustrating a functional configuration for executing a representative image extraction process in the second embodiment among functional configurations of the image capture apparatus in FIG. 1;

FIG. 7 is a flowchart illustrating an example of a flow of the representative image extraction process executed by an image capture apparatus as the first embodiment of the present invention having the functional configuration of FIG. 6;

FIG. 8 is a flowchart illustrating a flow of a representative image extraction process in Modified Example of the first embodiment; and

FIG. 9 is a flowchart illustrating a flow of a highlighted moving image generation process for generating a highlighted moving image by using a representative image selected by taking into consideration similarities with images arranged before and after.

### DETAILED DESCRIPTION OF THE INVENTION

Hereinafter, embodiments of the present invention will be described with reference to the drawings.

### First Embodiment

### [Hardware Configuration]

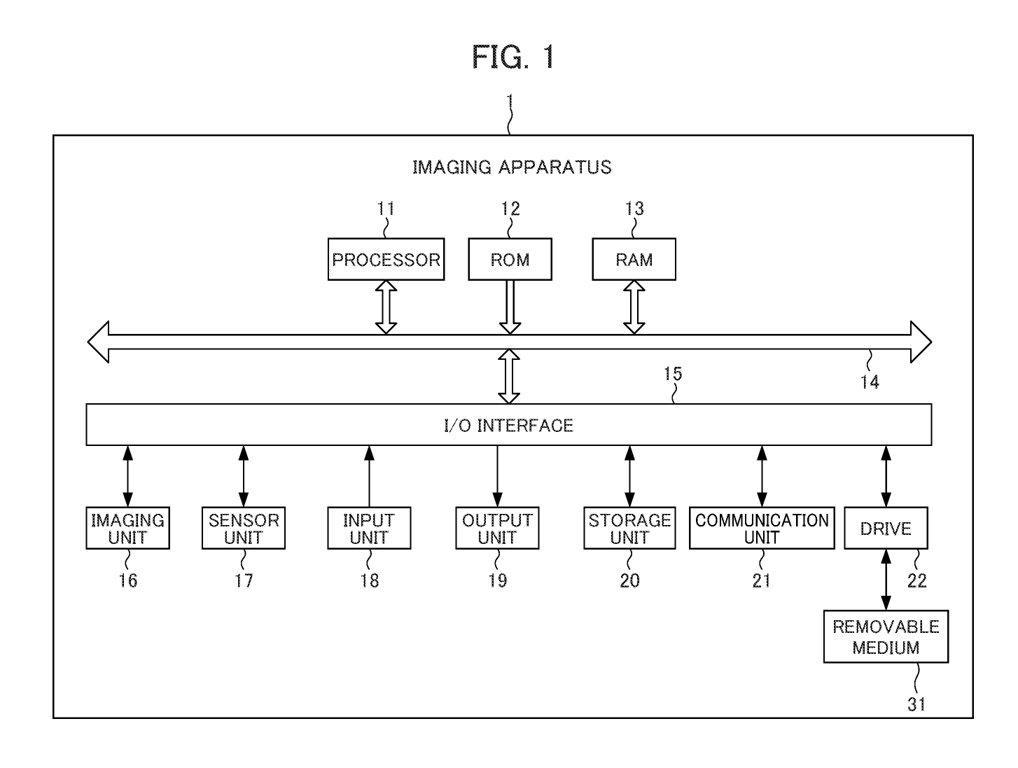

FIG. 1 is a block diagram showing the configuration of the hardware of the image capture apparatus 1. The image capture apparatus 1 is realized as an embodiment of an image processing apparatus according to the present invention, and is formed as a digital camera, for example.

As shown in FIG. 1, the image capture apparatus 1 includes a processor 11, a read only memory (ROM) 12, a random access memory (RAM) 13, a bus 14, an input-output interface 15, an image capture unit 16, a sensor unit 17, an input unit 18, an output unit 19, a storage unit 20, a communication unit 21, and a drive 22.

The processor 11 executes various types of processing according to a program stored in the ROM 12 or a program loaded from the storage unit 20 into the RAM 13.

Data and the like required by the processor 11 executing the various processing is stored in the RAM 13 as appropriate.

The processor 11, the ROM 12, and the RAM 13 are connected to each other via the bus 14. In addition, the input/output interface 15 is also connected to this bus 14. The input-output interface 15 is further connected to the image capture unit 16, the sensor unit 17, the input unit 18, the output unit 19, the storage unit 20, the communication unit 21, and the drive 22.

The image capture unit 16 includes an optical lens unit and an image sensor, which are not shown.

In order to photograph a subject, the optical lens unit is configured by a lens such as a focus lens and a zoom lens for condensing light. The focus lens is a lens for forming an image of a subject on the light receiving surface of the image sensor. The zoom lens is a lens that causes the focal length to freely change in a certain range. The optical lens unit also includes peripheral circuits to adjust setting parameters such as focus, exposure, white balance, and the like, as necessary.

The image sensor is configured by an optoelectronic conversion device, an AFE (Analog Front End), and the like. The optoelectronic conversion device is constituted by an optical sensor such as an optoelectronic conversion device of a CMOS (Complementary Metal Oxide Semiconductor) type. A subject image is incident upon the optoelectronic conversion device through the optical lens unit. The optoelectronic conversion device optoelectronically converts (i.e. captures) the image of the subject, accumulates the resultant image signal for a predetermined period of time, and sequentially supplies the image signal as an analog signal to the AFE. The AFE executes a variety of signal processing such as A/D (Analog/Digital) conversion processing of the analog signal. The variety of signal processing generates a digital signal that is output as an output signal from the image capture unit 16. The output signal of the image capture unit 16 will be hereinafter referred to as “captured image”. The data of the captured image are provided to the processor 11 and an image processing unit and the like, not shown.

The sensor unit 17 is formed with various types of sensors such as an acceleration sensor and a gyro sensor. In the present embodiment, when the image capture unit 16 performs imaging, sensor information about imaging is obtained and stored in association with the captured image.

The input unit 18 is constituted by various buttons, and the like, and inputs a variety of information in accordance with instruction operations by the user.

The output unit 19 is constituted by a display, a speaker, and the like, and outputs images and sound.

The storage unit 20 is constituted by DRAM (Dynamic Random Access Memory) or the like, and stores various kinds of data.

The communication unit 21 controls communication with a different apparatus via the network 300 including the Internet.

A removable medium 31 composed of a magnetic disk, an optical disk, a magneto-optical disk, a semiconductor memory or the like is loaded in the drive 22, as necessary. Programs that are read via the drive 22 from the removable medium 31 are installed in the storage unit 20, as necessary. Like the storage unit 20, the removable medium 31 can also store a variety of data such as data of images stored in the storage unit 20.

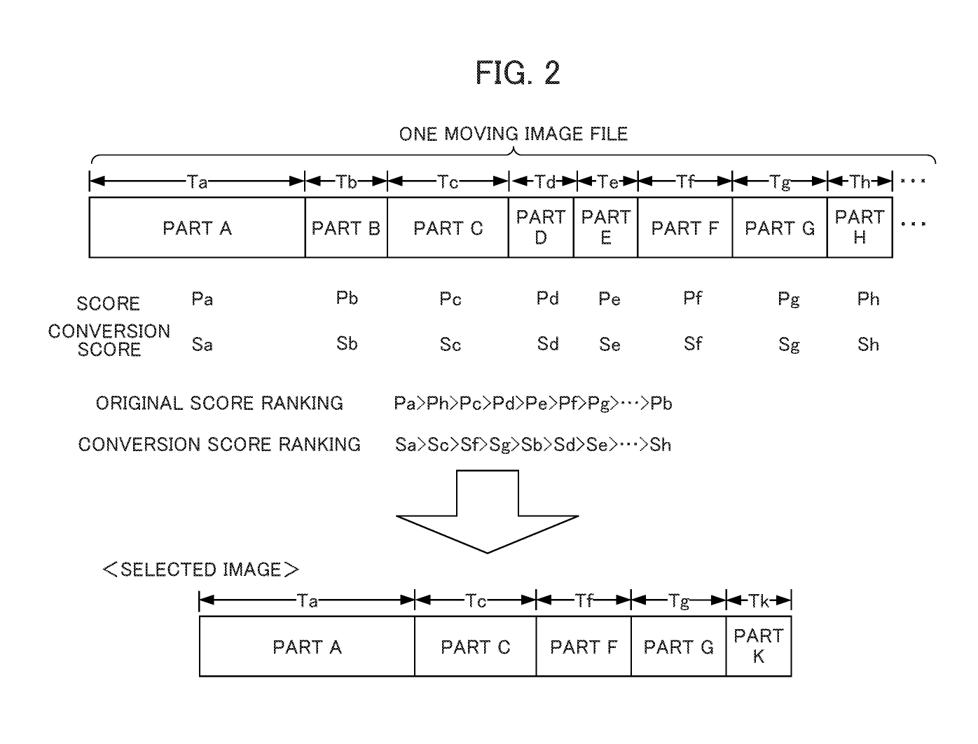

Herein, a method of generating an aggregate image in this embodiment will be described. An aggregate image is a single image obtained by aggregating characteristic images from one or a plurality of images (including a portion or all of the images). In addition, the image as a target herein may include both a still image and a moving image. In this embodiment, partial moving images (hereinafter, referred to as “partial moving images”) obtained by partitioning one moving image file is set as candidate images, and a characteristic partial moving image among these candidate images is selected as a representative image. Then, by aggregating these representative images, one moving image (aggregate image) is generated. In addition, it is also possible to generate an aggregate image from the candidate images other than the moving images of the moving image file and the selected partial moving image (representative image of the moving image file). FIG. 2 is a schematic diagram illustrating an aggregate image generated in the first embodiment of the present invention. As illustrated in FIG. 2, in the first embodiment of the present invention, one moving image file is partitioned into partial moving images at time sections Ta, Tb, Tc, Td, Te, Tf, Tg, Th, . . . , and each partial moving image is extracted. Then, an aggregate image is generated by selecting a portion of the partial moving images based on the scores determined from the similarities and the feature amounts from the plurality of partial moving images Part A, Part B, Part C, Part D, Part E, Part F, Part G, Part H, . . . , and Part K. That is, the aggregate image in this embodiment is a highlighted moving image obtained by aggregating partial moving images selected from one moving image file on condition that the similarity is lower and the score is higher.

Herein, in generation of the highlighted moving image or in advance, the scores of the partial moving images are set in the partial moving images Part A, Part B, Part C, Part D, Part E, Part F, Part G, Part H, . . . . The score of the partial moving image may be set based on, for example, the feature amount of the partial moving image. As the feature amount of the partial moving image, an indicator (for example, the fact that the face of a person is reflected, blurring is small, or the like) calculated by analyzing the content of the image or an indicator (suitability of photographing situation or the like) calculated from the imaging parameter or sensor information at the time of photographing can be used. In addition, with respect to the feature amount of the partial moving image, the feature amount obtained by averaging the feature amounts calculated for each frame may be set as the feature amount of the partial moving image, or the representative value (maximum value, minimum value, or the like) of the feature amount in the partial moving image may be adopted as the feature amount. In addition, the score of the partial moving image is set based on the feature amount of the partial moving image. However, the score of the partial moving image may be set based on the feature amount for each indicators calculated by analyzing the content of the image or for each type of photographing parameters (focal length, shutter speed, and the like) at the time of photographing. Furthermore, in the case of setting the scores of a plurality of partial moving images, the scores of the plurality of partial moving images may be set based on the feature amounts of the same type of indicators or the same type of photographing parameters. As a result, it is possible to set the score of the partial moving image with higher accuracy.

As illustrated in FIG. 2, the scores Pa, Pb, Pc, Pd, Pe, Pf, Pg, Ph . . . are set in the partial moving images Part A, Part B, Part C, Part D, Part E, Part F, Part G, Part H, . . . . Then, the conversion scores Sa, Sb, Sc, Sd, Se, Sf, Sg, Sh, . . . taking into consideration similarities with partial moving images Part A, Part B, Part C, Part D, Part E, Part F, Part G, Part H, . . . for the reference partial moving image Px (the latest selected partial moving image to be described later) are calculated from the scores Pa, Pb, Pc, Pd, Pe, Pf, Pg, Ph, . . . by the representative image extraction process to be described later. Herein, the conversion score is calculated by an operation of lowering the score of the partial moving image as the similarity with the reference partial moving image Px is higher.

As a result, the ranking of the score having the relationship of Pa>Ph>Pc>Pd>Pe>Pf>Pg> . . . becomes, as an example, conversion scores of Sa>Sc>Sf>Sg>Sb>Sd>Se> . . . >Sh. That is, with respect to the reference partial moving image Px, the partial moving image Part A having the highest conversion score is stored in the buffer as an image (representative image) representing the moving image. By sequentially performing such a process on the latest selected partial moving image (representative image), a partial moving image having a lower similarity with the previously selected representative image and having a higher score is selected as the representative image.

### [Functional Configuration]

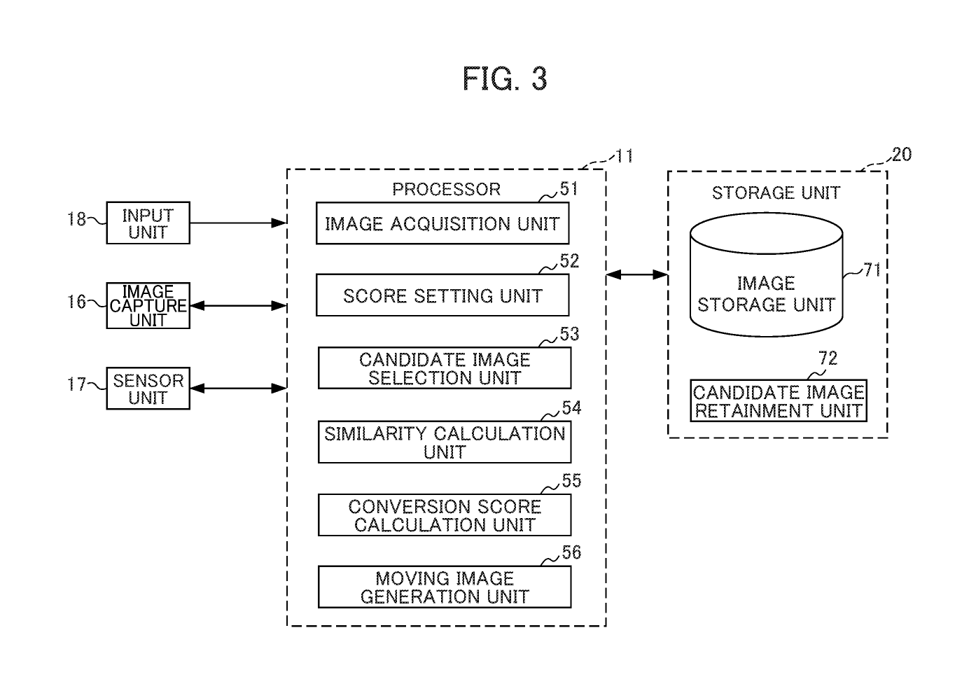

FIG. 3 is a functional block diagram illustrating a functional configuration for executing a representative image extraction process in the functional configuration of the image capture apparatus 1 in FIG. 1.

The representative image extraction process is a series of processes of selecting a partial moving image which is a combination having a high score as a representative image by taking into consideration similarity among the partial moving images (partial moving images) obtained by partitioning one moving image file.

As illustrated in FIG. 2, in a case where the representative image extraction process is executed, in the processor 11, the image acquisition unit 51, the score setting unit 52, the candidate image selection unit 53, the similarity calculation unit 54, the conversion score calculation unit 55, and the moving image generation unit 56 are allowed to function.

In one area of the storage unit 20, an image storage unit 71 and a candidate image retainment unit 72 are defined. The image storage unit 71 stores data of various moving images acquired by the image acquisition unit 51. In this embodiment, accompanying information such as photographing parameters and sensor information acquired at the time of photographing is associated with the moving image data. A representative image tentatively selected during the representative image extraction process is stored in the candidate image retainment unit 72. That is, the candidate image retainment unit 72 serves as a buffer tentatively storing the representative image.

The image acquisition unit 51 acquires, from the image storage unit 71, the data of the moving image file to be subjected to the representative image extraction process. The score setting unit 52 calculates a feature amount for each partial moving image specified in the acquired moving image file and sets the score of each partial moving image (evaluates the partial moving image) based on the feature amount. In this embodiment, the feature amount of the partial moving image is calculated based on the feature points and the like in the analyzed image that is obtained by image analysis of the partial image. In addition, the score of the partial moving image may be automatically set from the feature amount, or the user may set the score of the partial moving image by referring to the feature amount.

The candidate image selection unit 53 first selects a partial moving image having the highest score from the partial moving images (candidate images) in the moving image file. The candidate image selection unit 53 selects the partial moving image having the highest conversion score as the next partial moving image based on the conversion score of the other partial moving image calculated by the conversion score calculation unit 55. After that, the candidate image selection unit 53 sequentially selects the partial moving images having the highest conversion score based on the conversion scores of the other partial moving images calculated by the conversion score calculation unit 55 with respect to the latest selected partial moving image until the reproduction time set for the highlighted moving image is satisfied. In addition, the partial moving images selected by the candidate image selection unit 53 are sequentially stored in the buffer of which the storage capacity is set in advance.

The similarity calculation unit 54 calculates the similarity between the latest selected partial moving image and each of the other unselected partial moving images. The conversion score calculation unit 55 calculates the conversion score of the other unselected partial moving image with respect to the latest selected partial moving image based on the similarity calculated by the similarity calculation unit 54 and the score of each partial moving image. The conversion score is a score taking into consideration the similarity of the two partial moving images and, as an example, is calculated by multiplying the similarity and the score of each of the other unselected partial moving images with respect to the reference partial moving image (herein, the latest selected partial moving image). In addition, the similarity used here is a parameter that becomes lower as the similarity between the two partial moving images is higher. The moving image generation unit 56 generates the highlighted moving image by arranging the partial moving images (representative images) selected by the candidate image selection unit 53 in time-series order in the moving image file and combining the partial moving images. In addition, in a case where the user instructs the moving image generation unit 56 to generate a highlighted moving image from the partial moving image in the buffer selected by the representative image extraction process, the moving image generation unit generates and outputs the highlighted moving image. On the other hand, in a case where the user does not instruct the moving image generation unit to generate a highlighted moving image from the partial moving image in the buffer selected by the representative image extraction process, the representative image in the buffer is output as the result of the representative image extraction process. The partial moving image in the buffer output as the result of the representative image extraction process can be used as a candidate image in generation of an aggregate image (highlighted moving image) with respect to a moving image of the moving image file and a plurality of other still images or moving images as a target as a representative image representing the moving image file.

### [Operations]

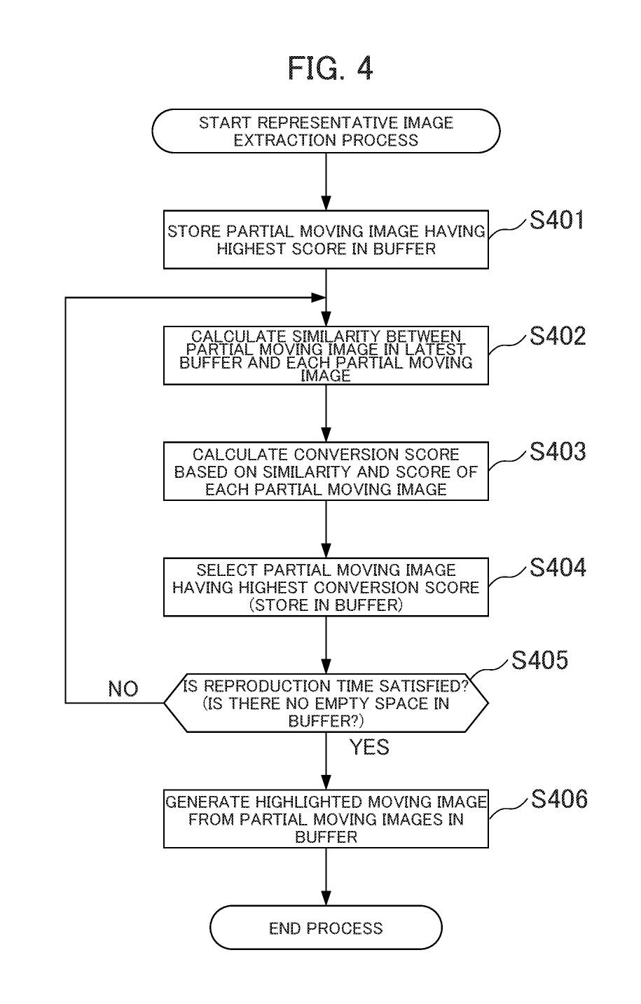

Next, operations of the image capture apparatus 1 will be described. FIG. 4 is a flowchart illustrating a flow of a representative image extraction process executed by the image capture apparatus according to the first embodiment of the present invention having the functional configuration of FIG. 3. The representative image extraction process is started by an operation of starting the representative image extraction process on the input unit 18 by the user. In Step S401, the candidate image selection unit 53 selects the partial moving image having the highest score from each partial moving image in the moving image file and stores the selected partial moving image in the buffer (the candidate image retainment unit 72 in FIG. 3).

In Step S402, the similarity calculation unit 54 calculates the similarity between the latest selected partial moving image (the latest partial moving image stored in the buffer) and each of the other unselected partial moving images.

In Step S403, based on the similarity calculated by the similarity calculation unit 54 and the score of each partial moving image, the conversion score calculation unit 55 calculates the conversion score of the other unselected partial moving image with respect to the latest selected partial moving image.

In Step S404, the candidate image selection unit 53 selects the partial moving image having the highest conversion score as the next partial moving image based on the conversion score of the other partial moving image calculated by the conversion score calculation unit 55. In Step S405, the candidate image selection unit 53 determines whether or not the reproduction time set for the highlighted moving image is satisfied (whether or not there is an empty space in the buffer). In a case where the reproduction time set for the highlighted moving image is satisfied (there is no empty space in the buffer), YES is determined in Step S405, and the process proceeds to Step S402.

On the other hand, in a case where the reproduction time set for the highlighted moving image is not satisfied (there is an empty space in the buffer), NO is determined in Step S405, and the process proceeds to Step S406. In Step S406, the moving image generation unit 56 generates the highlighted moving image by arranging the partial moving images (representative images) selected by the candidate image selection unit 53 in time-series order in the moving image file and combining the partial moving images. In addition, in a case where the user instructs the moving image generation unit 56 to generate a highlighted moving image from the partial moving images in the buffer selected by the representative image extraction process, the moving image generation unit generates and outputs the highlighted moving image. On the other hand, in a case where the user does not instruct the moving image generation unit to generate a highlighted moving image from the partial moving image in the buffer selected by the representative image extraction process, the representative image in the buffer is output as the result of the representative image extraction process. After Step S406, the representative image extraction process is ended.

With such a process, among the partial moving images constituting the moving image file, the partial moving image having the highest score is selected, and the remaining partial moving images are sequentially selected according to the conversion scores taking into consideration the similarity with the latest selected partial moving image. Therefore, it is possible to suppress similar partial moving images from being selected, and it is possible to generate a highlighted moving image highly attractive to the user.

### Second Embodiment

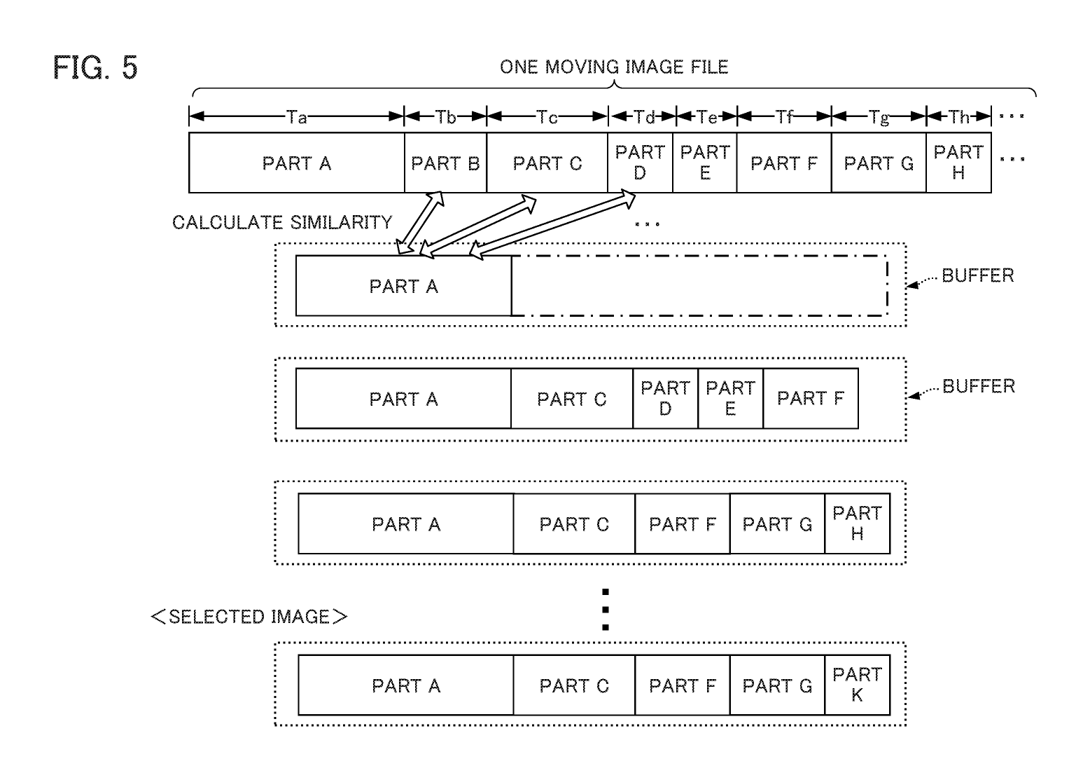

Next, a second embodiment of the present invention will be described. FIG. 5 is a schematic diagram illustrating an aggregate image generated in the second embodiment. The second embodiment of FIG. 5 is the same as the case of the first embodiment in FIG. 2 in that one moving image file is partitioned into partial moving image at time sections Ta, Tb, Tc, Td, Te, Tf, Tg, Th, . . . , and the aggregate image is obtained by selecting characteristic partial images.

Herein, in generation of the highlighted moving image or in advance, the scores of the partial moving images are set in the partial moving images Part A, Part B, Part C, Part D, Part E, Part F, Part G, Part H, . . . . A method of setting the score of the partial moving image is the same as in the first embodiment.

In the second embodiment, in generation of a highlighted moving image, as illustrated in FIG. 5, first, one partial moving image, for example, the leading Part A among the partial moving images Part A, Part B, Part C, Part D, Part E, Part F, Part G, Part H, . . . is stored in the buffer. Then, the similarity between the partial moving image already stored in the buffer and the all remaining partial moving images in the moving image file is calculated. Based on the similarity calculated as described above, the partial moving images having low similarity are added to the buffer and retained or are replaced with the partial moving images already retained in the buffer. That is, in a case where the similarity with the partial moving image already stored in the buffer is low, in a case where there is an empty space in the buffer, the partial moving image is added and retained. In a case where there is no empty space in the buffer, in a case where the score is higher than the partial moving image in the buffer, the partial moving image retained in the buffer is replaced. In addition, if the similarity with the partial moving image already stored in the buffer is high, if the score is higher than the partial moving image in the buffer, the partial moving image retained in the buffer is replaced. The above-described process is sequentially executed in time-series order on the partial moving images constituting the moving image file.

As a result, in the example of FIG. 5, five partial moving images Part A, Part C, Part F, Part G, and Part K are retained in the buffer, and these partial moving images become the representative images of the moving image file.

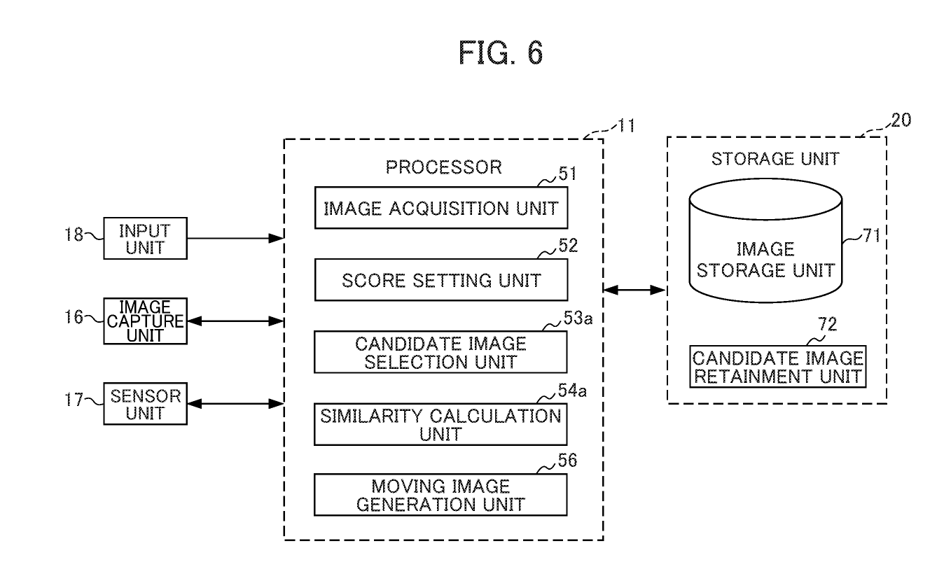

FIG. 6 is a functional block diagram illustrating a functional configuration for executing a representative image extraction process in the second embodiment among the functional configurations of the image capture apparatus in FIG. 1.

The image capture apparatus 1 according to this embodiment is different from the image capture apparatus 1 according to the first embodiment in terms of the functional configuration of the candidate image selection unit 53a and the similarity calculation unit 54a and the contents of the representative image extraction process. In the image capture apparatus 1 according to this embodiment, the conversion score calculation unit 55 is not provided.

Hereinafter, the configurations different from the first embodiment will be mainly described. The candidate image selection unit 53a first selects one partial moving image from the partial moving images in the moving image file. At this time, it is possible to select, for example, the leading partial moving image. Then, the candidate image selection unit 53a sequentially determines whether or not to select each partial moving image from the leading side in the moving image file. That is, the candidate image selection unit 53a performs addition of the partial moving image to buffer or replacement of the partial moving image based on the similarity between the next partial moving image in time series and each partial moving image (each partial moving image in the buffer) already selected, which are calculated by the similarity calculation unit 54a.

As an example, in a case where the similarity between the partial moving image in the buffer and the next partial moving image in time series is high, the candidate image selection unit 53a compares the score of the next partial moving image in time series with the score of the partial moving image having high similarity in the buffer. Then, in a case where the score of the next partial moving image in time series is higher than the score of the partial moving image having high similarity in the buffer, the candidate image selection unit 53a replaces the partial moving image having the lowest score among the partial moving images having high similarity in the buffer with the next partial moving image in time series.

In a case where the similarity between the partial moving image in the buffer and the next partial moving image in time series is low, if there is an empty space in the buffer, the candidate image selection unit 53a adds the next partial moving image in time series to the buffer. On the other hand, in a case where the similarity between the partial moving image in the buffer and the next partial moving image in time series is low, if there is no empty space in the buffer, the candidate image selection unit 53a compares the score of the next partial moving image in time series with the lowest score of the partial moving image in the buffer. Then, in a case where the score of the next partial moving image in time series is higher than the lowest score of the partial moving image in the buffer, the candidate image selection unit 53a replaces the partial moving image having the lowest score with the next partial moving image in the time series. The candidate image selection unit 53a repeats such a process up to the last partial moving image in time series of the moving image file. The similarity calculation unit 54a calculates the similarity between each partial moving image already selected (each partial moving image in the buffer) and the next partial moving image in time series.

### [Operations]

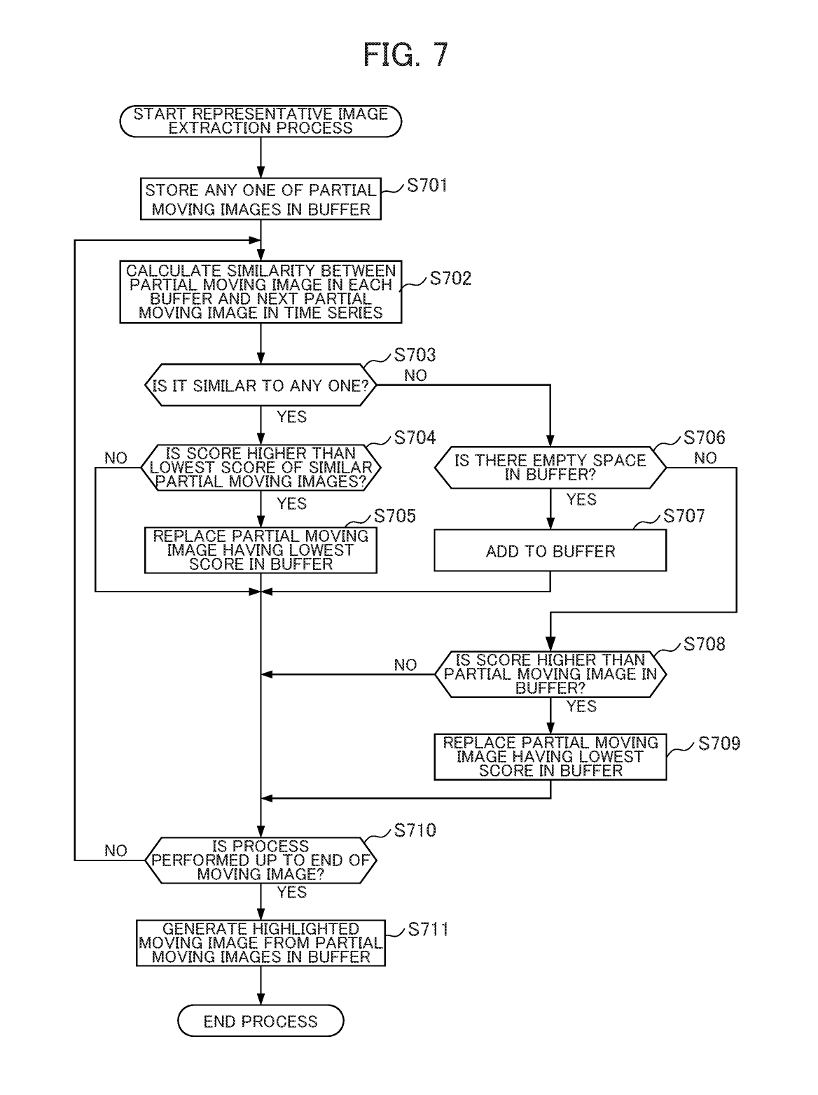

Next, operations of the image capture apparatus 1 will be described. FIG. 7 is a flowchart illustrating a flow of a representative image extraction process executed by the image capture apparatus 1 according to the second embodiment. The representative image extraction process is started by user's operation of starting the representative image extraction process on the input unit 18. In Step S701, the candidate image selection unit 53a selects one partial moving image (the leading partial moving image, or the like) among the partial moving images in the moving image file and stores the selected partial moving image in the buffer.

In Step S702, the similarity calculation unit 54a calculates the similarity between each partial moving image already selected (each partial moving image in the buffer) and the next partial moving image in time series. In Step S703, the candidate image selection unit 53a determines whether or not each partial moving image in the buffer is similar to the next partial moving image in time series. In a case where any partial moving image in the buffer is similar to the next partial moving image in time series, YES is determined in Step S703, and the process proceeds to Step S704. On the other hand, in a case where each partial moving image in the buffer is not similar to the next partial moving image in time series, NO is determined in Step S703, and the process proceeds to Step S706.

In Step S704, the candidate image selection unit 53a determines whether the score of the next partial moving image in time series is higher than the lowest score of the partial moving image (similar partial moving image) in the buffer. In a case where the score of the next partial moving image in time series is higher than the lowest score of the partial moving image (similar partial moving image) in the buffer, YES is determined in Step S704, and the process proceeds to Step S705. On the other hand, in a case where the score of the next partial moving image in time series is not higher than the lowest score of the partial moving image (similar partial moving image) in the buffer, NO is determined in Step S704, and the process proceeds to Step S710. In Step S705, the candidate image selection unit 53a replaces the partial moving image having the lowest score among the partial moving images having a high similarity with the next partial moving image in time series in the buffer. After Step S705, the process proceeds to Step S710.

In Step S706, the candidate image selection unit 53a determines whether or not there is an empty space in the buffer. In a case where there is an empty space in the buffer, YES is determined in Step S706, and the process proceeds to Step S707. In a case where there is no empty space in the buffer, NO is determined in Step S706, and the process proceeds to Step S708. In Step S707, the candidate image selection unit 53a adds the next partial moving image in time series to the buffer. After Step S707, the process proceeds to Step S710.

In Step S708, the candidate image selection unit 53a determines whether or not the score of the next partial moving image in time series is higher than the lowest score of the partial moving image in the buffer. In a case where the score of the next partial moving image in time series is higher than the lowest score of the partial moving image in the buffer, YES is determined in Step S708, and the process proceeds to Step S709. On the other hand, in a case where the score of the next partial moving image in time series is not higher than the lowest score of the partial moving image in the buffer, NO is determined in Step S708, and the process proceeds to Step S710.

In Step S709, the candidate image selection unit 53a replaces the partial moving image having the lowest score with the next partial moving image in time series in the buffer. In Step S710, the candidate image selection unit 53a determines whether or not the process is completed up to the last partial moving image of the moving image file.

In a case where the process is not completed up to the last partial moving image of the moving image file, NO is determined in Step S710, and the process proceeds to Step S702. On the other hand, in a case where the process is completed up to the last partial moving image of the moving image file, YES is determined in Step S710, and the process proceeds to Step S711.

In Step S711, the moving image generation unit 56 generates the highlighted moving image by arranging the partial moving images (representative images) selected by the candidate image selection unit 53a in time-series order in the moving image file and combining the partial moving images. In addition, in a case where the user instructs the moving image generation unit 56 to generate a highlighted moving image from the partial moving image in the buffer selected by the representative image extraction process, the moving image generation unit generates and outputs the highlighted moving image. On the other hand, in a case where the user does not instruct the moving image generation unit to generate a highlighted moving image from the partial moving image in the buffer selected by the representative image extraction process, the representative image in the buffer is output as the result of the representative image extraction process. After Step S711, the representative image extraction process is ended.

With such a process, by processing the partial moving images in the time series once from the leading side of the moving image file and by taking into consideration the similarity with the selected partial moving image, the partial moving images which are not similar to each other and have higher scores are selected. Therefore, it is possible to suppress similar partial moving images from being selected, and it is possible to generate a highlighted moving image highly attractive to the user.

### Modified Example 1

In the first embodiment, the candidate image selection unit 53 is configured to set the latest selected partial moving image as a target and to sequentially select the partial moving images having the highest conversion scores based on the conversion score of the other partial moving image calculated by the conversion score calculation unit 55 until the reproduction time set for the highlighted moving image is satisfied. On the other hand, the candidate image selection unit 53 may be configured to set the entire partial moving image already selected as a target and to select the partial moving image having the highest conversion score based on the conversion score of the other partial moving image calculated by the conversion score calculation unit 55.

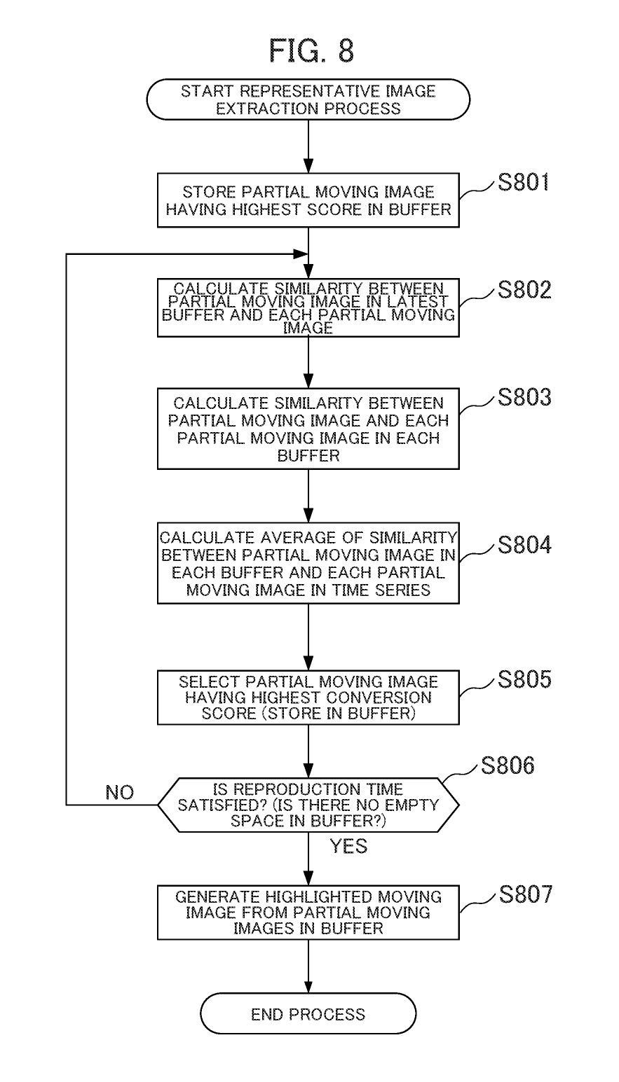

Hereinafter, a representative image extraction process in this Modified Example will be described. FIG. 8 is a flowchart illustrating a flow of the representative image extraction process in Modified Example 1. The representative image extraction process is started by a user's operation of starting the representative image extraction process on the input unit 18. In Step S801, the candidate image selection unit 53 selects the partial moving image having the highest score among the partial moving images in the moving image file and stores the selected partial moving image in the buffer. In Step S802, the similarity calculation unit 54 calculates the similarity between each selected partial moving image (each partial moving image in the buffer) and each of the other unselected partial moving images.

In Step S803, the similarity calculation unit 54 calculates an average value of similarities between each selected partial moving image (each partial moving image in the buffer) and one of the other unselected partial moving images. In Step S803, the similarity calculation unit 54 calculates the average value of the similarities with respect to the other unselected partial moving images. In Step S804, the conversion score calculation unit 55 calculates the conversion scores of the other unselected partial moving images with respect to the selected partial moving images based on the average value of the similarities calculated by the similarity calculation unit 54 and the scores of the partial moving images.

In Step S805, the candidate image selection unit 53 selects the partial moving image having the highest conversion score as the next partial moving image based on the conversion scores of the other partial moving images calculated by the conversion score calculation unit 55. In Step S806, the candidate image selection unit 53 determines whether or not the reproduction time set for the highlighted moving image is satisfied (whether or not there is an empty space in the buffer). In a case where the reproduction time set for the highlighted moving image is not satisfied (there is an empty space in the buffer), NO is determined in Step S806, and the process proceeds to Step S802. On the other hand, in a case where the reproduction time set for the highlighted moving image is satisfied (there is no empty space in the buffer), YES is determined in Step S806, and the process proceeds to Step S807.

In Step S807, the moving image generation unit 56 generates the highlighted moving image by arranging the partial moving images (representative images) selected by the candidate image selection unit 53 in time-series order in the moving image file and combining the partial moving images. In addition, in a case where the user instructs the moving image generation unit 56 to generate a highlighted moving image from the partial moving image in the buffer selected by the representative image extraction process, the moving image generation unit generates and outputs the highlighted moving image. On the other hand, in a case where the user does not instruct the moving image generation unit to generate a highlighted moving image from the partial moving image in the buffer selected by the representative image extraction process, the representative image in the buffer is output as the result of the representative image extraction process. After Step S807, the representative image extraction process is ended.

With such a process, the partial moving image having the highest score is selected among the partial moving images constituting the moving image file, and the remaining partial moving images are sequentially selected according to the conversion scores taking into consideration the similarity with the entire selected partial moving image. Therefore, it is possible suppress similar partial moving images from being selected, and it is possible to generate a highlighted moving image highly attractive to the user.

### Modified Example 2

In the embodiments and Modified Example described above, it is possible to generate an aggregate image (highlighted moving image) with respect to a plurality of still images or moving images as a target including moving images of a moving image file from which the partial moving image is selected by using the following method. That is, in execution of the representative image extraction process, candidate images arranged before and after the moving image file from which the partial moving image is selected are fixedly stored in the head and tail regions of the buffer. Then, the representative image representing the moving image file is selected by taking into consideration the similarities with the candidate images arranged before and after the moving image file from which the partial moving image is selected. That is, in the representative image extraction process, in selection of the partial moving image, by selecting a partial moving image having a lower similarity with the candidate image stored in the head of the buffer and having a higher score, it is possible to suppress the partial moving image similar to the candidate image before the moving image file from being selected as the representative image of the moving image file. Similarly, in the representative image extraction process, in selection of the partial moving image, by selecting a partial moving image having a lower similarity with the candidate image stored in the tail of the buffer and having a higher score, it is possible to suppress the partial moving image similar to the candidate image after the moving image file from being selected as the representative image of the moving image file. In addition, a predetermined number of candidate images before the moving image file from which the partial moving image is selected and a predetermined number of candidate images after the moving image file may be stored in the head and tail of the representative image. In addition, different numbers of candidate images may be stored in the buffer before and after the moving image file from which the partial moving image is selected. Furthermore, only the candidate images before or after the moving image file from which the partial moving image is selected may also be stored in the buffer. In this way, by executing the representative image extraction process, it is possible to suppress the representative image similar to the images before and after the moving image file from which the partial moving image is selected from being selected. According to this Modified Example, since one representative image representing the moving image file can be selected by taking into consideration the similarities with the candidate images arranged before and after the moving image file from which the partial moving image is selected, it is possible to select the representative image without storing the plurality of candidate images.

### Modified Example 3

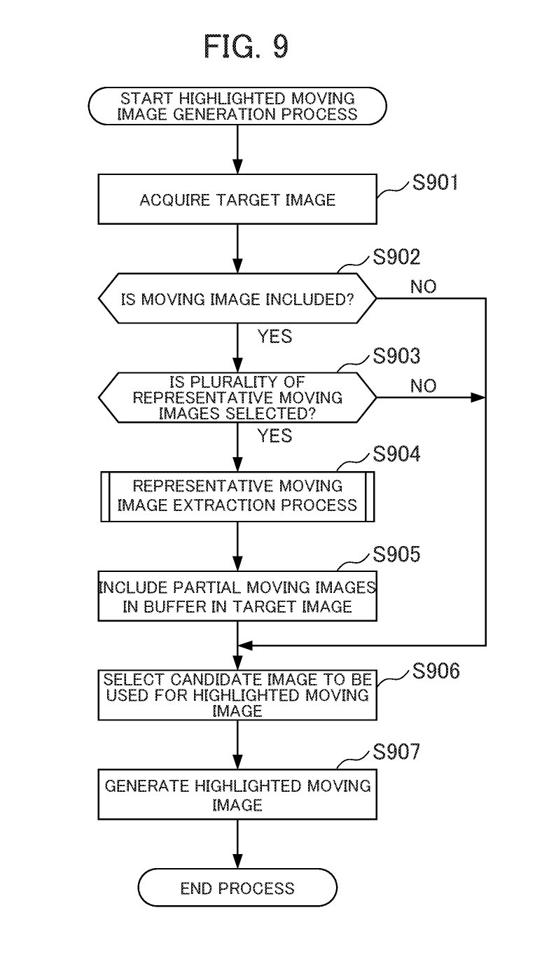

Besides the method illustrated in Modified Example 2, it is also possible to generate an aggregate image (highlighted moving image) with respect to a plurality of still images or moving images as a target including moving images of a moving image file from which the partial moving image is selected by using the following method. That is, in this Modified Example, an highlighted moving image (aggregate image) with respect to a plurality of still images or moving images as a target is generated by using the representative image selected by taking into consideration the similarities with the images arranged before and after the moving image file among a plurality of the representative images selected in the representative image extraction process. FIG. 9 is a flowchart illustrating a flow of the highlighted moving image generation process for generating the highlighted moving image by using the representative image selected by taking into consideration the similarities with the images arranged before and after the moving image file. The highlighted moving image generation process is started by user's operation of starting the highlighted moving image generation process on the input unit 18. In Step S901, the image acquisition unit 51 acquires an image as a target for generating a highlighted moving image. In Step S902, the candidate image selection unit 53 determines whether or not a moving image is contained in the acquired image. In a case where a moving image is contained in the acquired image, it is determined as “YES” in Step S902, and the process proceeds to Step S903. On the other hand, in a case where no moving image is contained in the acquired image, it is determined as “NO” in Step S902, and the process proceeds to Step S906. In Step S903, the candidate image selection unit 53 determines whether or not setting of selecting a plurality of representative images from the moving image in the highlighted moving image generation process is performed. This setting may be performed in advance by the user prior to the start of the highlighted moving image generation process. In Step S904, a representative image extraction process is executed. In addition, as the representative image extraction process executed herein, it is possible to employ any of the representative image extraction process in the first embodiment, the representative image extraction process in the second embodiment, and the representative image extraction process in Modified Example 1. In Step S904, the partial moving image in the buffer selected by the representative image extraction process is output as a result of the process. In Step S905, the image acquisition unit 51 allows the partial moving image in the buffer output in Step S904 to be included in an image as a target for generating the highlighted moving image. In addition, the partial moving images (representative images) in the buffer are handled in association with a set of candidate image groups representing moving image files. In Step S906, the candidate image selection unit 53 selects a candidate image to be used for the highlighted moving image based on the score of the image on the condition of the number of images or the reproduction time. At this time, in a case where the moving image file represented by the candidate image group in the buffer is selected as used for the highlighted moving image, the candidate image selection unit 53 selects a representative image having a lower similarity and higher score than those of these images as the partial moving image used for the highlighted moving image by taking into consideration the similarities with the images arranged before and after the moving image file. In Step S907, the moving image generation unit 56 generates a highlighted moving image by synthesizing the image selected in Step S906 as a moving image. After Step S907, the highlighted moving image generation process ends. With such a process, it is possible to generate a highlighted moving image (aggregate image) with respect to a plurality of still images and moving images as a target by using the representative image selected by taking into consideration the similarities with the images arranged before and after the moving image file among the representative images selected in the representative image extraction process. Therefore, it is possible to provide a highlighted moving image highly attractive to the user.

The image capture apparatus 1 configured as described above includes an image acquisition unit 51, a candidate image selection unit 53 (candidate image selection unit 53a), a similarity calculation unit 54, and a moving image generation unit 56. The image acquisition unit 51 acquires a moving image. The moving image generation unit 56 generates a single image by combining the representative image of the moving image and the plurality of images different from the moving image. The similarity calculation unit 54 calculates the similarity between an image synthesized temporally or spatially before or after the moving image by the moving image generation unit 56 and the moving image. The candidate image selection unit 53 specifies the representative image from the moving image based on the calculation result of the similarity calculation unit 54. In this way, it is possible to specify the representative image from the moving image by taking into consideration the similarity with the image synthesized temporally or spatially before or after the moving image. Consequently, it is possible to provide an aggregate image highly attractive to the user.

The candidate image selection unit 53 selects a plurality of candidate images from the moving images acquired by the image acquisition unit 51. The candidate image selection unit 53 selects a representative image from the plurality of candidate images based on the calculation result of the similarity calculation unit 54. Thus, it is possible to select a representative moving image from the plurality of candidate images in the moving images, taking into consideration the similarity with an image synthesized temporally or spatially before or after the moving image.

The image capture apparatus 1 includes a score setting unit 52. The score setting unit 52 evaluates the plurality of candidate images specified by the image acquisition unit 51. The candidate image selection unit 53 selects a representative image from the plurality of candidate images according to the evaluation result by the score setting unit 52 and the calculation result by the similarity calculation unit 54. Thus, it is possible to select a representative image according to the evaluation result of each candidate image and the calculated similarity.

The similarity calculation unit 54 calculates the similarities between a plurality of images displayed temporally or spatially before or after the moving image and the moving image. This makes it possible to select a candidate image by taking into consideration the similarities with the images displayed up to a predetermined number before or up to a predetermined number after the candidate image.

The similarity calculation unit 54 calculates the similarity between images displayed temporally or spatially before and after the moving image and the moving image. Therefore, it is possible to select a candidate image by taking into consideration the similarities with the images displayed before and after the candidate image.

In addition, the image capture apparatus 1 configured as described above includes a candidate image selection unit 53 (candidate image selection unit 53a) and a moving image generation unit 56. With respect to a candidate image that is a portion or the entire of the image, the candidate image selection unit 53 selects the candidate image among the plurality of candidate images based on the score set for the candidate image and the similarities between the candidate image and the other candidate images. The moving image generation unit 56 generates an aggregate image based on the candidate image selected by the candidate image selection unit 53. As a result, it is possible to select a partial moving image based on the score with similarity taken into consideration. Therefore, it is possible to suppress similar partial moving images from being selected, and it is possible to generate an aggregate image highly attractive to the user.

The image capture apparatus 1 includes a score setting unit 52 and a similarity calculation unit 54 (similarity calculation unit 54a). The score setting unit 52 sets a score for each of the candidate images. The similarity calculation unit 54 calculates similarities between the candidate image and the other candidate images. As a result, in the image capture apparatus 1, it is possible to set the score of the candidate image, calculate the similarities among the candidate images, and select the candidate image.

The image capture apparatus 1 includes a conversion score calculation unit 55. The conversion score calculation unit 55 calculates a conversion score that is a score reflecting a similarity based on the similarity between the candidate image of interest and another candidate image and the score of the candidate image of interest. The candidate image selection unit 53 selects a candidate image based on the conversion score calculated by the conversion score calculation unit 55. As a result, since it is possible to select a partial moving image based on the conversion score reflecting the similarity between the candidate images, it is possible to improve the attractiveness of the aggregate image.

The similarity is a similarity between each candidate image already selected by the candidate image selection unit 53 and another candidate image. Based on the similarity between each candidate image already selected by the candidate image selection unit 53 and another candidate image and the score of the candidate image of interest, the conversion score calculation unit 55 calculates a conversion score which is a score reflecting the similarity between each of the candidate images and another candidate image. The candidate image selection unit 53 selects a candidate image based on the conversion score. As a result, since it is possible to select a partial moving image based on the conversion score reflecting the similarity between the entire candidate image already selected and the candidate image of interest, it is possible to improve the attractiveness of the aggregate image.

In a case where the score of the candidate image of interest is higher than the lowest score of the candidate image already selected by the candidate image selection unit 53, the candidate image selection unit 53 selects the candidate image of interest instead of the candidate image having the lowest score. As a result, it is possible to sequentially select the candidate images having higher scores instead of the candidate images already selected.

In addition, the present invention is not limited to the above-described embodiment, but includes variations, improvements, combinations of embodiments, modified examples, and the like within the scope of the present invention. For example, aggregate images generated according to the present invention include those in which images are aggregated in various forms such as a highlighted moving image, a slide show, or a collage image in a temporal or spatial manner.

Although in the embodiment described above, a digital camera is adopted as an example for explaining the image capture apparatus 1 to which the present invention is applied, but the embodiment is not limited thereto. For example, the present invention can be applied to electronic devices in general that include a representative image extraction function. For example, the present invention can be applied to a notebook type personal computer, a printer, a television receiver, a camcorder, a portable type navigation device, a cellular phone, a smartphone, a portable game device, and the like.

The functions of the image capture apparatus 1 according to the above embodiment can be implemented as being distributed to a plurality of information processing apparatuses. For example, the setting of the scores of the candidate images and the calculation of the similarities may be executed by another information processing apparatus, and the image capture apparatus 1 may obtain the score and the similarities to select the candidate images. The selection of the candidate images may be executed by an information processing apparatus other than the image capture apparatus 1, and the image capture apparatus 1 may obtain and display the processing result.

In the above embodiments, a similarity between a moving image and a candidate image synthesized temporally or spatially before or after the moving image is calculated, and a representative image is specified from the candidate images on the basis of the calculation result, but the embodiments are not limited thereto.

For example, in the present invention, similarities between feature amounts of a plurality of candidate images and a feature amount of a temporally first section or a temporally last section of a moving image may be calculated, and an image synthesized temporally before or after the moving image can be specified from the plurality of images on the basis of the calculation result. In this case, redundancy in successive images can be eliminated.

The processing sequence described above can be executed by hardware, and can also be executed by software. In other words, the hardware configurations of FIG. 3 and FIG. 4 are merely illustrative examples, and the present invention is not particularly limited thereto. More specifically, the types of functional blocks employed to realize the above-described functions are not particularly limited to the examples shown in FIG. 3 and FIG. 4, so long as the image capture apparatus 1 can be provided with the functions enabling the aforementioned processing sequence to be executed in its entirety. A single functional block may be constituted by a single piece of hardware, a single installation of software, or a combination thereof. The functional configurations of the present embodiment are realized by a processor executing arithmetic processing, and processors that can be used for the present embodiment include a unit configured by a single unit of a variety of single processing devices such as a single processor, multi-processor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or recording medium to a computer or the like. The computer may be a computer equipped with dedicated hardware. In addition, the computer may be a computer capable of executing various functions, e.g., a general purpose personal computer, by installing various programs.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM 12 of FIG. 1 in which the program is recorded, and a hard disk included in the storage unit 20 of FIG. 1, and the like.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image processing apparatus comprising:
a memory; and
a processor,
wherein the processor executes a program stored in a memory to perform operations comprising:
acquiring a moving image;
calculating a similarity between the moving image and a candidate image which is to be synthesized temporally or spatially before or after the moving image;
specifying a representative image from the moving image based on the calculation result; and
generating a single image by combining the specified representative image and an image which includes the candidate image and which is different from the moving image.

2. The image processing apparatus according to claim 1,
wherein the processor perform operations comprising:
selecting a plurality of candidate images from the acquired moving image; and
selecting the representative image from the plurality of candidate images based on the calculation result.

3. The image processing apparatus according to claim 2,
wherein the processor perform operations comprising:
evaluating the plurality of specified candidate images; and
selecting the representative image from the plurality of candidate images according to the evaluation result and the calculation result.

4. The image processing apparatus according to claim 2,
wherein perform operations comprising:
evaluating the plurality of candidate images based on a feature amount of the moving image.

5. The image processing apparatus according to claim 4, wherein the feature amount is obtained by averaging feature amounts calculated for frames of the moving image.

6. The image processing apparatus according to claim 4, wherein the feature amount is a maximum value or a minimum value of a feature amount calculated for each frame of the moving image.

7. The image processing apparatus according to claim 4, wherein the feature amount is a feature amount calculated based on a type of an indicator of a frame image of the moving image.

8. The image processing apparatus according to claim 4, wherein the feature amount is a feature amount calculated based on a type of a photographing parameter of a frame image of the moving image.

9. The image processing apparatus according to claim 4,
wherein the processor perform operations comprising:
evaluating the plurality of candidate images based on feature amounts of the same type of the moving image.

10. The image processing apparatus according to claim 1,
wherein the processor perform operations comprising:
calculating similarities between the moving image and a plurality of candidate images displayed temporally or spatially before or after the moving image.

11. The image processing apparatus according to claim 1,
wherein the processor perform operations comprising:
calculating a similarity between a candidate image displayed temporally or spatially before or after the moving image and the moving image.

12. The image processing apparatus according to claim 1,
wherein the processor perform operations comprising:
specifying the moving image of which calculation result is lower than other calculation result as a representative image.

13. The image processing apparatus according to claim 1,
wherein the processor perform operations comprising:
calculating an average value of similarities between a partial moving image of the moving image and other partial moving images of the moving image.

14. An image processing apparatus comprising:
a memory; and
a processor,
wherein the processor executes a program stored in a memory to perform operations comprising:
acquiring a plurality of moving images;
calculating a similarity between the moving image and a candidate image which is to be synthesized temporally or spatially before or after the moving image;
specifying a representative image from the moving image based on the calculation result; and
generating one representative image by combining the specified representative image and an image which includes the candidate image and which is different from the moving image.

15. An image processing method executed by an image processing apparatus including a processor, the image processing method causes the processor to execute a program stored in a memory to perform operations comprising:
acquiring a moving image,
calculating a similarity between the moving image a candidate image synthesized temporally or spatially before or after the moving image;
specifying a representative image from the moving image based on a result of the calculation process; and
generating a single image by combining the representative image specified by the specifying process and an image different from the moving image.

16. A non-transitory computer-readable storage medium storing a program that is executable by a computer that comprises a processor, the program being executable to cause the computer to perform operations comprising:
acquiring a moving image;
calculating a similarity between a candidate image synthesized temporally or spatially before or after the moving image and the moving image;
specifying a representative image from the moving image based on a calculation result of the calculation function; and
generating a single image by combining the specified representative image and an image which includes the candidate image and which is different from the moving image.
